(19) United States
(12) Patent Application Publication
(10) Pub. No.: US 2024/0329254 A1
(43) Pub. Date: Oct. 3, 2024

(54) SIGNAL PROCESSING APPARATUS AND SIGNAL PROCESSING METHOD

(71) Applicant: Sony Group Corporation, Tokyo (JP)

(72) Inventors: Motonobu FUJIOKA, Kanagawa (JP); Yusuke MORIUCHI, Kanagawa (JP); Kenichiro NAKAMURA, Saitama (JP); Takayuki SASAKI, Tokyo (JP); Hajime MIHARA, Tokyo (JP)

(73) Assignee: Sony Group Corporation, Tokyo (JP)

(21) Appl. No.: 18/580,008

(22) PCT Filed: Mar. 1, 2022
(86) PCT No.: PCT/JP2022/008489

§ 371 Date: Jan. 17, 2024

(30) Foreign Application Priority Data
Jul. 26, 2021 (JP) 2021-121297

(51) Int. Cl. G01S 17/894; G01C 3/06; G01S 17/86

(52) U.S. Cl. CPC G01S 17/894; G01C 3/06; G01S 17/86

(57) ABSTRACT

There is provided a signal processing apparatus and a signal processing method enabling correction of a deviation of position information of a dToF sensor. The signal processing apparatus includes: a data acquisition unit configured to acquire a distance histogram that is histogram data of time of flight of irradiation light at a predetermined distance measurement point of a distance measurement sensor; a check target determination unit configured to determine whether or not the predetermined distance measurement point is a distance measurement point as a positional deviation check target; and a coordinate correction unit configured to execute correction processing of correcting three-dimensional coordinates of the predetermined distance measurement point, the three-dimensional coordinates being computed from the distance histogram, on the basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target. The technology of the present disclosure can be applied to, for example, a signal processing apparatus or the like that calculates three-dimensional coordinates of an object by using a distance histogram output from a distance measurement sensor.

### TECHNICAL FIELD

The present disclosure relates to a signal processing apparatus and a signal processing method, and more particularly to a signal processing apparatus and a signal processing method capable of correcting a deviation of position information of a dToF sensor.

### BACKGROUND ART

A ToF sensor of a direct ToF method (hereinafter, also referred to as a dToF sensor) detects reflected light, which is pulse light reflected by an object, using a light receiving element referred to as a single photon avalanche diode (SPAD) in each pixel for light reception. In order to reduce noise caused by ambient light or the like, emission of the pulse light and reception of the reflected light thereof are repeated a predetermined number of times (for example, several to several hundred times), and the dToF sensor generates a histogram of time of flight of the pulse light, and calculates a distance to the object from the time of flight corresponding to a peak of the histogram.

It is known that an SN ratio is low and it is difficult to detect a peak position in distance measurement of a low-reflectivity or distant subject, distance measurement under an environment where external light has a strong influence of disturbance such as an outdoor environment, and the like. Therefore, by allowing the emitted pulse light to have a spot shape, a reach distance of the pulse light is expanded, in other words, the number of detection of the reflected light is increased. Since the spot-shaped pulse light is generally sparse pulse light, pixels that detect the reflected light are also sparse according to a spot diameter and an irradiation area.

In order to improve the SN ratio and to reduce power by efficient pixel driving according to the sparse reflected light detection environment, a plurality of adjacent pixels (referred to as a multipixel) of a part of a pixel array is regarded as one large pixel, and a light receiving operation is performed in units of multipixels to generate a histogram. For example, Patent Document 1 discloses a method of increasing an SN ratio instead of lowering a spatial resolution, by forming a multipixel by using any number of adjacent pixels such as two by three, three by three, three by six, three by nine, six by three, six by six, and nine by nine, creating a histogram by using signals of the multipixel, and calculating a distance.

A distance measurement sensor such as a dToF sensor is, for example, used together with an RGB camera in a volumetric capture technology for generating a 3D object of a subject from a moving image captured from multiple viewpoints and generating a virtual viewpoint image of the 3D object according to any viewing position. Furthermore, a distance measurement sensor such as the dToF sensor is also used together with the RGB camera in simultaneous localization and mapping (SLAM) or the like that simultaneously performs self position estimation and environmental map creation.

### CITATION LIST

### Patent Document

Patent Document 1: Japanese Patent Application Laid-Open No. 2020-112443

### SUMMARY OF THE INVENTION

### Problems to be Solved by the Invention

When three-dimensional position information of a distance measurement point acquired by the dToF sensor is made to correspond to a captured image obtained by the RGB camera, a deviation may occur in the position information acquired by the dToF sensor due to a calibration error, a distance measurement error, a deviation in exposure timing, or the like.

The present disclosure has been made in view of such a situation, and enables correction of a deviation of position information of a dToF sensor.

### Solutions to Problems

A signal processing apparatus according to one aspect of the present disclosure includes: an acquisition unit configured to acquire a distance histogram that is histogram data of time of flight of irradiation light at a predetermined distance measurement point of a distance measurement sensor; a determination unit configured to determine whether or not the predetermined distance measurement point is a distance measurement point as a positional deviation check target; and a correction unit configured to execute correction processing of correcting three-dimensional coordinates of the predetermined distance measurement point, the three-dimensional coordinates being computed from the distance histogram, on the basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.

A signal processing method according to one aspect of the present disclosure includes, by a signal processing apparatus: acquiring a distance histogram that is histogram data of time of flight of irradiation light at a predetermined distance measurement point of a distance measurement sensor; determining whether or not the predetermined distance measurement point is a distance measurement point as a positional deviation check target; and executing correction processing of correcting three-dimensional coordinates of the predetermined distance measurement point, the three-dimensional coordinates being computed from the distance histogram, on the basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.

In one aspect of the present disclosure, a distance histogram is acquired, which is histogram data of time of flight of irradiation light at a predetermined distance measurement point of a distance measurement sensor, determination is made as to whether or not the predetermined distance measurement point is a distance measurement point as a positional deviation check target, and correction processing of correcting three-dimensional coordinates that is of the predetermined distance measurement point and is computed from the distance histogram is executed on the basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.

Note that the signal processing apparatus according to one aspect of the present disclosure can be implemented by causing a computer to execute a program. Furthermore, the program to be executed by the computer for realizing the signal processing apparatus according to one aspect of the present disclosure can be provided by being transmitted via a transmission medium or by being recorded on a recording medium.

The signal processing apparatus may be an independent device or a module incorporated in another device.

### BRIEF DESCRIPTION OF DRAWINGS

FIG. 1 is a block diagram illustrating a configuration example of a first embodiment of a signal processing system of the present disclosure.

FIG. 2 is a diagram for explaining operations of an RGB camera and a dToF sensor in FIG. 1.

FIG. 3 is a view for explaining the dToF sensor.

FIG. 4 is a view for explaining a positional deviation correction function of the present disclosure.

FIG. 5 is a graph for explaining a peak region of a distance histogram.

FIG. 6 is a view for explaining check target determination processing performed by a check target determination unit.

FIG. 7 is a view for explaining positional deviation correction processing of a coordinate correction unit.

FIG. 8 is a view for explaining a similarity calculation method.

FIG. 9 is a view for explaining a similarity calculation method.

FIG. 10 is a flowchart illustrating position information calculation processing performed by the signal processing system of the first embodiment.

FIG. 11 is a block diagram illustrating a configuration example of a second embodiment of a signal processing system of the present disclosure.

FIG. 12 is a view for explaining check target determination processing of a check target determination unit.

FIG. 13 is a view for explaining the check target determination processing of the check target determination unit.

FIG. 14 is a block diagram illustrating a configuration example of hardware of a computer that executes signal processing of the present disclosure.

### MODE FOR CARRYING OUT THE INVENTION

Hereinafter, modes for carrying out the technique of the present disclosure (hereinafter, referred to as embodiments) will be described with reference to the accompanying drawings. Note that, in the present specification and the drawings, components having substantially the same functional configurations are denoted by the same reference signs, and redundant descriptions are omitted. The description will be given in the following order.
1. First embodiment of signal processing system
2. Check target determination processing of check target determination unit
3. Positional deviation correction processing of coordinate correction unit
4. Position information calculation processing according to first embodiment
5. Second embodiment of signal processing system
6. Position information calculation processing according to second embodiment
7. Conclusion
8. Computer configuration example

### 1. First Embodiment of Signal Processing System

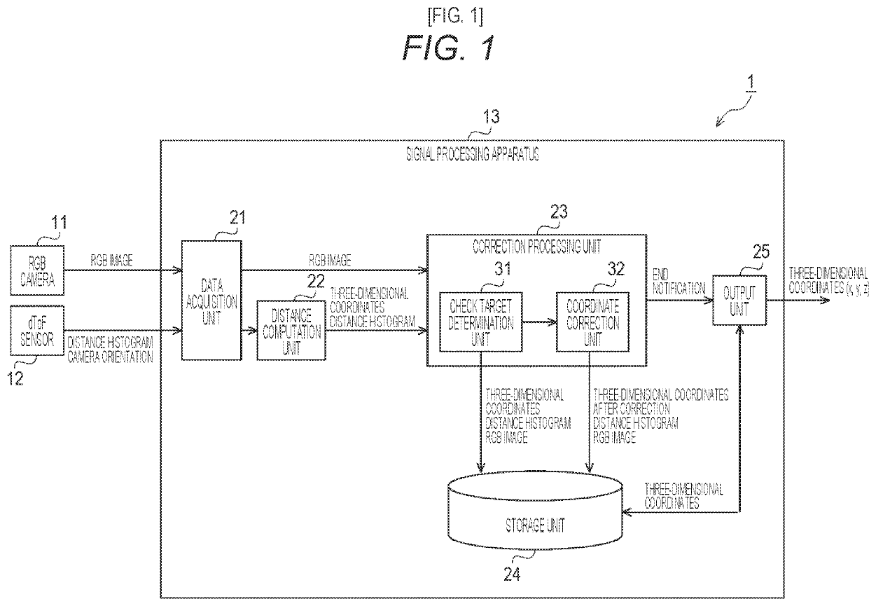

FIG. 1 is a block diagram illustrating a configuration example of a first embodiment of a signal processing system of the present disclosure.

A signal processing system 1 in FIG. 1 includes an RGB camera 11, a dToF sensor 12, and a signal processing apparatus 13.

The signal processing apparatus 13 includes a data acquisition unit 21, a distance computation unit 22, a correction processing unit 23, a storage unit 24, and an output unit 25. The correction processing unit 23 includes a check target determination unit 31 and a coordinate correction unit 32.

The RGB camera 11 captures an image of a predetermined object as a subject, generates (a moving image of) an RGB image, and supplies the RGB image to the signal processing apparatus 13. The dToF sensor 12 is a distance measurement sensor configured to acquire distance information between with a subject by using a direct ToF method, and acquires distance information between with the same object as the object whose image is captured by the RGB camera 11. A relative positional relationship between the RGB camera 11 and the dToF sensor 12 is fixed, and imaging ranges of the RGB camera 11 and the dToF sensor 12 are calibrated. In other words, the imaging ranges of the RGB camera 11 and the dToF sensor 12 are the same, and a correspondence relationship of individual pixels between the RGB camera 11 and the dToF sensor 12 is known. In the present embodiment, in order to simplify the description, it is assumed that a difference in position between the RGB camera 11 and the dToF sensor 12 is negligible, and camera positions (camera orientations) of the RGB camera 11 and the dToF sensor 12 are the same.

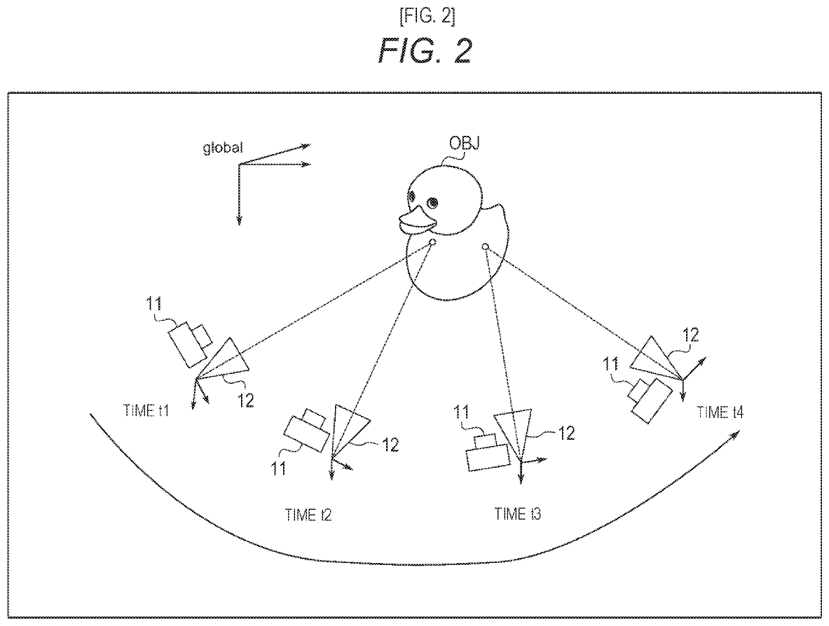

As illustrated in FIG. 2, the RGB camera 11 captures an image of an object OBJ as a subject while moving an image-capturing place in accordance with a lapse of time, to generate an RGB image. The dToF sensor 12 moves together with the RGB camera 11 and receives reflected light obtained by the object OBJ reflecting a plurality of beams of spot light (irradiation light) emitted from a light emitting source (not illustrated), thereby acquiring a distance histogram as distance information of the object OBJ. The distance histogram is histogram data of time of flight of irradiation light corresponding to a distance to the object OBJ.

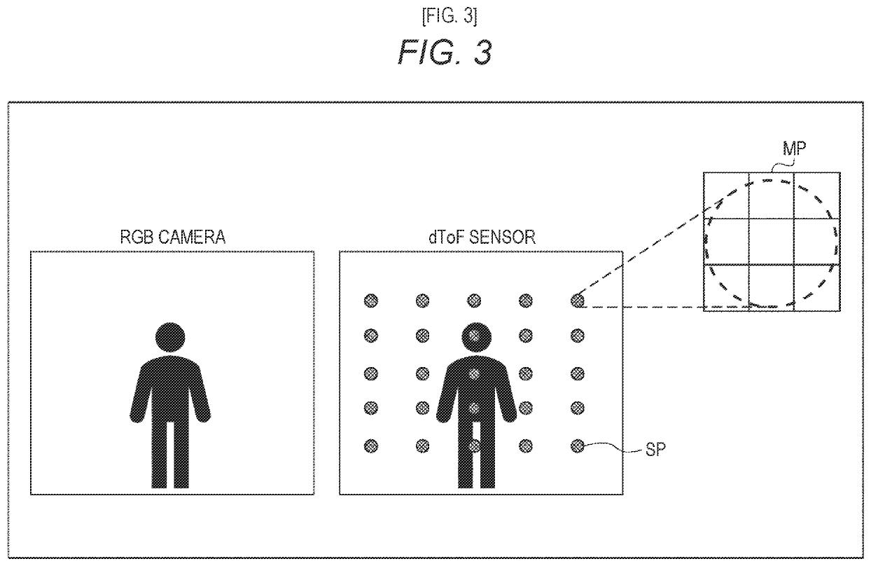

The dToF sensor 12 will be briefly described with reference to FIG. 3.

The dToF sensor 12 detects reflected light, which is obtained when pulse light as irradiation light is reflected by an object, by using a light receiving element called a single photon avalanche diode (SPAD) in each pixel for light reception. In order to reduce noise caused by ambient light or the like, the dToF sensor 12 repeats emission of the pulse light and reception of the reflected light thereof a predetermined number of times (for example, several to several hundred times) to generate a histogram of time of flight of the pulse light, and outputs a distance histogram. A unit of outputting the distance histogram once for the same imaging range as that of the RGB camera 11 is referred to as one frame following the RGB camera 11.

It is known that an SN ratio is low and it is difficult to detect a peak position in distance measurement of a low-reflectivity or distant subject, distance measurement under an environment where external light has a strong influence of disturbance such as an outdoor environment, and the like. Therefore, by allowing the emitted pulse light to have a spot shape, a reach distance of the pulse light is expanded, in other words, the number of detection of the reflected light is increased. Since the spot-shaped pulse light is generally sparse pulse light, pixels that detect the reflected light are also sparse according to a spot diameter and an irradiation area. FIG. 3 illustrates an example in which the same imaging range as that of the RGB camera 11 is irradiated with spot light SP of 5×5=25, and reflected light that is each beam of the spot light SP being reflected by an object is detected.

In order to improve the SN ratio and to reduce power by efficient pixel driving according to the sparse reflected light detection environment, the dToF sensor 12 sets a plurality of adjacent pixels as a multipixel MP in accordance with the sparse spot light SP, and causes only a plurality of multipixels MP among all the pixels of a pixel array to perform a light receiving operation, to generate a histogram in units of the multipixels MP. In the example of FIG. 3, the multipixel MP of nine pixels of 3×3 is set for one beam of the spot light SP.

Note that, in FIG. 3, an example of the spot light SP of 5×5=25 and the multipixel MP of nine pixels of 3×3 has been described, but the number and arrangement of the spot light SP and the multipixel MP are freely determined. In the following description, in a case where the spot light SP and the multipixel MP are not particularly distinguished, a point corresponding to the spot light SP and the multipixel MP is also referred to as a distance measurement point.

The RGB camera 11 in FIG. 1 generates (a moving image of) an RGB image obtained by capturing an image of a predetermined object as a subject every moment, and supplies the RGB image to the signal processing apparatus 13. The dToF sensor 12 supplies, to the signal processing apparatus 13, a distance histogram obtained by receiving the reflected light that is the spot light SP emitted to a predetermined object as a subject and reflected by the object, and a camera orientation at the time of acquiring the distance histogram. The distance histogram includes histogram data and a pixel position (x, y) corresponding to a center of the spot light SP detected by the dToF sensor 12. The camera orientation is information of an external parameter of the dToF sensor 12 detected by an inertial measurement unit (IMU) in the dToF sensor 12. However, the dToF sensor 12 may not include the inertial measurement unit (IMU). In that case, the dToF sensor 12 outputs only the distance histogram, and the camera orientation of the dToF sensor 12 is calculated, for example, by calculating three-dimensional position information of a corresponding (same) distance measurement point in each frame by a method such as normal distribution transform in the distance computation unit 22 or the like in the signal processing apparatus 13.

The signal processing apparatus 13 acquires the RGB image captured by the RGB camera 11 and the distance histogram and the camera orientation generated by the dToF sensor 12, and generates and outputs three-dimensional coordinates of a predetermined object as a subject on a global coordinate system. In the following description, it is assumed that three-dimensional coordinates on the global coordinate system are represented even in a case of being simply described as three-dimensional coordinates.

That is, the signal processing apparatus 13 is a signal processing apparatus that performs processing of calculating three-dimensional coordinates of a predetermined object as a subject on the global coordinate system, on the basis of the distance histogram generated by the dToF sensor 12 and the camera orientation at that time. At that time, the signal processing apparatus 13 has a positional deviation correction function of correcting a positional deviation in a case where the calculated three-dimensional coordinates of the object are deviated from a position of the object on the RGB image due to a calibration error, a distance measurement error, a deviation in exposure timing, or the like.

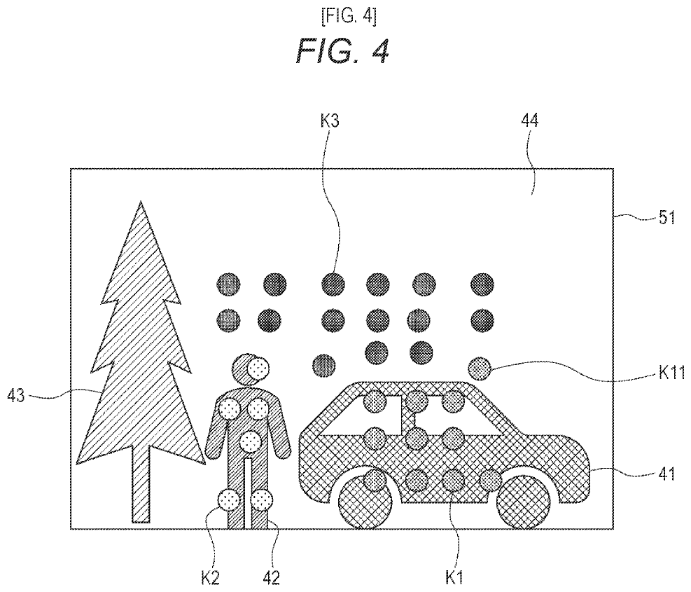

FIG. 4 illustrates a view in which each distance measurement point before positional deviation correction calculated on the basis of the distance histogram acquired from the dToF sensor 12 is superimposed on an RGB image captured by the RGB camera 11.

In an RGB image 51 captured by the RGB camera 11, a car (automobile) 41, a person (pedestrian) 42, and a tree 43 are shown as subjects. A circle with a predetermined pattern illustrated by being superimposed on the RGB image 51 represents a distance measurement point K of the dToF sensor 12. The pattern attached to each distance measurement point K illustrated in FIG. 4 is classified into three types of patterns of distance measurement points K1, K2, and K3, in accordance with the calculated distance (three-dimensional coordinates) to the object. The distance measurement point K1 is a distance measurement point having a distance (three-dimensional coordinates) corresponding to the car 41. The distance measurement point K2 is a distance measurement point having a distance (three-dimensional coordinates) corresponding to the person 42. The distance measurement point K3 is a distance measurement point having a distance (three-dimensional coordinates) corresponding to a background 44 other than the car 41, the person 42, and the tree 43. The background 44 is, for example, a wall of a building.

Here, attention is paid to one predetermined distance measurement point K11 among a large number of distance measurement points K of the dToF sensor 12. As a distance (three-dimensional coordinates) calculated on the basis of the distance histogram, the distance measurement point K11 has a distance corresponding to the car 41. However, the three-dimensional coordinates of the distance measurement point K11 calculated on the basis of the distance histogram are not a position of the car 41 but a position of the background 44. Such a positional deviation of the distance measurement point K11 occurs, for example, due to a calibration error or a distance measurement error of the dToF sensor 12. Alternatively, in a case where the distance histogram of the entire image-capturing range of the RGB camera 11 is acquired by sectioning the distance histogram into a plurality of frames because the number of distance measurement points K acquired by the dToF sensor 12 in one frame is small and sparse, such a positional deviation occurs due to a deviation in acquisition timing (exposure timing) of the distance histogram, movement of the object, or the like.

The signal processing apparatus 13 executes positional deviation correction processing of correcting a positional deviation of three-dimensional coordinates of the distance measurement point K such as the distance measurement point K11, and outputs the three-dimensional coordinates of each distance measurement point K. In the example of the distance measurement point K11, on the RGB image 51 of FIG. 4, the current distance measurement point K11 is corrected to a position in a lower left direction, and the positional deviation of the three-dimensional coordinates is corrected such that the three-dimensional coordinates become the position of the car 41.

Returning to the description of FIG. 1, the data acquisition unit 21 of the signal processing apparatus 13 acquires the RGB image supplied from the RGB camera 11 and the distance histogram and the camera orientation supplied from the dToF sensor 12. The data acquisition unit 21 supplies the acquired RGB image to the correction processing unit 23, and supplies the acquired distance histogram and camera orientation to the distance computation unit 22.

The distance computation unit 22 computes three-dimensional coordinates (x, y, z) for every distance measurement point of the dToF sensor 12, on the basis of the distance histogram and the camera orientation from the data acquisition unit 21. More specifically, the distance computation unit 22 detects a peak region of a count value from histogram data of the multipixel MP corresponding to the spot light SP, and computes three-dimensional coordinates (x, y, z) from the detected peak region and the camera orientation.

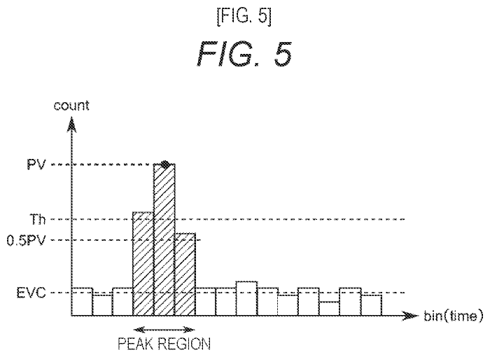

Here, the peak region is detected as follows. For example, as illustrated in FIG. 5, a bin in which a count value is equal to or greater than a predetermined threshold value Th and a count value (peak) PV is largest among a plurality of adjacent bins, as well as a plurality of bins around that bin, are detected as the peak regions. The plurality of bins around the peak may be defined as, for example, bins being around a peak and having a count value equal to or greater than a certain percentage (for example, 0.5 PV which is half of the peak PV) of the count value of the peak PV, or may be defined as a predetermined number of bins before and after the bin of the peak PV. In the example of FIG. 5, three hatched bins are detected as peak regions, that is, a bin of the peak PV and two bins having count values equal to or greater than 0.5 PV around that bin. Three-dimensional coordinates (x, y, z) are calculated from the detected peak region and the camera orientation.

Furthermore, as in the example of FIG. 5, the distance computation unit 22 can detect, as a disturbance light intensity, a median value EVC of count values of bins other than the detected peak region.

The distance computation unit 22 supplies, to the correction processing unit 23, the distance histogram and the three-dimensional coordinates (x, y, z) of each distance measurement point computed from the distance histogram and the camera orientation. Note that the distance computation unit 22 may supply the histogram data of the peak region and the disturbance light intensity to the correction processing unit 23, instead of the distance histogram.

The correction processing unit 23 determines whether or not the positional deviation needs to be corrected with respect to the computed three-dimensional coordinates of each distance measurement point, by using the RGB image supplied from the data acquisition unit 21 and the three-dimensional coordinates (x, y, z) of each distance measurement point, and the distance histogram supplied from the distance computation unit 22. Then, in a case where it is determined that the positional deviation needs to be corrected, the correction processing unit 23 executes the positional deviation correction processing, and moves (corrects) the three-dimensional coordinates of the distance measurement point.

Specifically, the check target determination unit 31 and the coordinate correction unit 32 of the correction processing unit 23 set each of a plurality of distance measurement points included in one frame of the dToF sensor 12 as a distance measurement point of interest, and perform the following processing.

The check target determination unit 31 determines whether or not the distance measurement point of interest is a distance measurement point as a positional deviation check target, in other words, whether or not the distance measurement point of interest is a distance measurement point in which a positional deviation has highly possibly occurred. When determining that the distance measurement point of interest is a distance measurement point as a positional deviation check target, the check target determination unit 31 instructs the coordinate correction unit 32 to execute the positional deviation correction processing on the distance measurement point of interest. Whereas, when determining that the distance measurement point of interest is not a distance measurement point as a positional deviation check target, the check target determination unit 31 supplies the three-dimensional coordinates (x, y, z) of the distance measurement point of interest computed by the distance computation unit 22 and the distance histogram as they are (without performing the positional deviation correction processing) to the storage unit 24 to store.

In a case where execution of the positional deviation correction processing of the distance measurement point of interest is instructed from the check target determination unit 31, the coordinate correction unit 32 executes the positional deviation correction processing on the distance measurement point of interest. As the positional deviation correction processing, the coordinate correction unit 32 determines whether or not the positional deviation needs to be corrected, and executes processing of correcting (moving) the three-dimensional coordinates (x, y, z) of the distance measurement point of interest computed by the distance computation unit 22 when determining that the positional deviation needs to be corrected. The three-dimensional coordinates (x, y, z) and the distance histogram of the distance measurement point of interest after the positional deviation correction processing are supplied to and stored in the storage unit 24.

Furthermore, the correction processing unit 23 also supplies, at a predetermined timing, the RGB image supplied from the data acquisition unit 21, to the storage unit 24 to store. Either the check target determination unit 31 or the coordinate correction unit 32 may cause the storage unit 24 to store the RGB image.

When the processing has been completed for all the frames of the plurality of frames sequentially supplied from the dToF sensor 12, the correction processing unit 23 supplies an end notification to the output unit 25.

When the end notification is supplied from the correction processing unit 23, the output unit 25 outputs the three-dimensional coordinates of each distance measurement point of all the frames stored in the storage unit 24, as the three-dimensional coordinates after the correction processing.

Note that the correction processing unit 23 may supply the end notification to the output unit 25 in units of frames, for a plurality of frames sequentially supplied from the dToF sensor 12. In this case, the output unit 25 acquires the three-dimensional coordinates after the correction processing from the storage unit 24 in units of frames, and outputs the three-dimensional coordinates.

The signal processing apparatus 13 has the above configuration. Details of the correction processing unit 23 of the signal processing apparatus 13 will be further described below.

### <2. Check Target Determination Processing of Check Target Determination Unit>

Next, check target determination processing performed by the check target determination unit 31 will be described.

The check target determination unit 31 determines whether or not the distance measurement point of interest is a distance measurement point as a check target, in other words, whether or not the distance measurement point of interest is a distance measurement point in which a positional deviation has highly possibly occurred.

Specifically, the positional deviation is likely to occur near an object boundary, or an influence of the positional deviation is large in a case where the positional deviation has occurred near the object boundary. Therefore, the check target determination unit 31 extracts a region near the object boundary as an edge region, from the RGB image captured by the RGB camera 11. Then, in a case where the distance measurement point of interest is included in the edge region, the check target determination unit 31 determines that the distance measurement point of interest is a distance measurement point as a check target in which a positional deviation has highly possibly occurred.

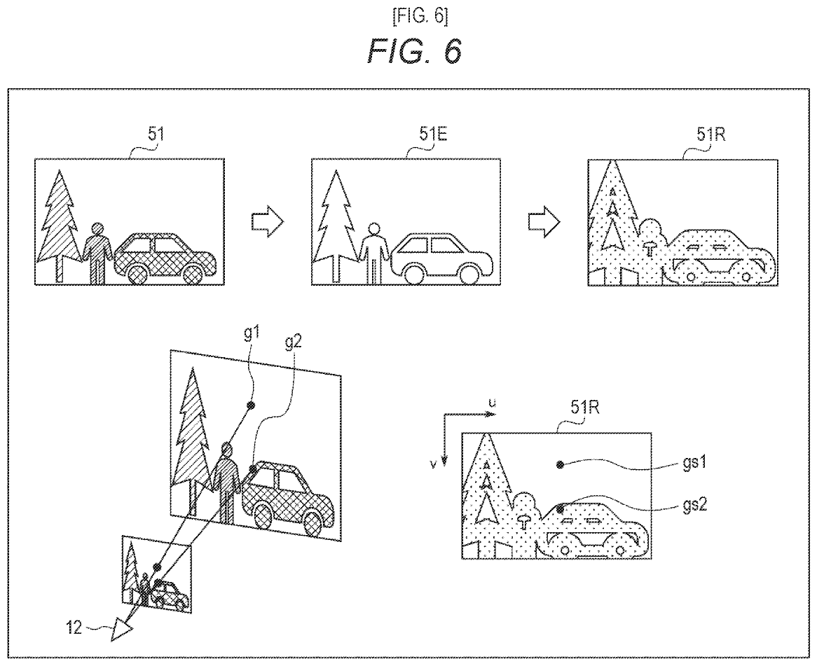

FIG. 6 is a view for explaining the check target determination processing performed by the check target determination unit 31.

First, the check target determination unit 31 detects an edge of the RGB image 51 captured by the RGB camera 11, by using, for example, Canny's method or the like. An edge image 51E in FIG. 6 is an image in which the edge detected from the RGB image 51 is expressed by a black pixel value.

Next, the check target determination unit 31 determines an edge region having a predetermined width from the edge, by executing filtering processing of expanding the black pixel for N times (N is an integer of 2 or more) on the edge image 51E in which the edge is detected. In the example of FIG. 6, a region indicated by a dot pattern in an edge region image 51R indicates an edge region determined on the basis of the edge image 51E.

Note that the edge region may be determined by a method other than the expansion processing described above. For example, a region where motion has been detected from past several frames may be determined as the edge region. More specifically, by using the RGB image of past frames stored in the storage unit 24 and the RGB image of a current frame as inputs, a region in which the number of times of the expansion processing is increased for a portion with large motion in a dense optical flow image obtained by the Gunnar-Farneback method or the like may be determined as the edge region.

Next, the check target determination unit 31 uses camera internal parameters of the RGB camera 11 to obtain screen coordinates (u, v), on the RGB image 51, corresponding to the three-dimensional coordinates of the distance measurement point of interest. Then, in a case where the screen coordinates (u, v) of the distance measurement point of interest on the RGB image 51 are included in the edge region, the check target determination unit 31 determines that the distance measurement point of interest is a distance measurement point as a check target. Whereas, in a case where the screen coordinates (u, v) of the distance measurement point of interest on the RGB image 51 are located outside the edge region, it is determined that the distance measurement point of interest is not a distance measurement point as a check target. Note that camera internal parameters of the RGB camera 11 for converting the three-dimensional coordinates of the distance measurement point of interest into screen coordinates (u, v) are known.

In the example of FIG. 6, in a case where the distance measurement point of interest is a distance measurement point g1, screen coordinates (u, v) of a corresponding point gs1 of the distance measurement point g1 on the RGB image 51 are outside the edge region. Therefore, the distance measurement point g1 is determined not to be a distance measurement point as a check target.

On the other hand, in a case where the distance measurement point of interest is a distance measurement point g2, screen coordinates (u, v) of a corresponding point gs2 of the distance measurement point g2 on the RGB image 51 are in the edge region. Therefore, the distance measurement point g2 is determined to be a distance measurement point as a check target.

### <3. Positional Deviation Correction Processing of Coordinate Correction Unit>

Next, a description is given to the positional deviation correction processing executed by the coordinate correction unit 32 when the distance measurement point of interest is determined to be a distance measurement point as a check target.

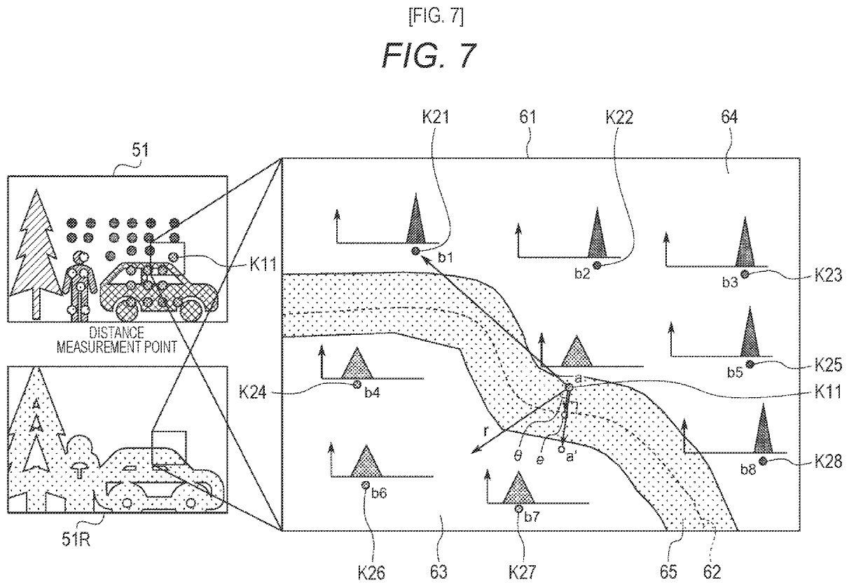

FIG. 7 is a view for explaining the positional deviation correction processing performed by the coordinate correction unit 32 when the distance measurement point K11 of the RGB image 51 illustrated in FIG. 4 is determined to be a distance measurement point as a check target.

FIG. 7 illustrates an enlarged region 61 obtained by enlarging a peripheral region including the distance measurement point K11 of the RGB image 51 illustrated in FIG. 4. Furthermore, the enlarged region 61 includes, in addition to the distance measurement point K11, eight distance measurement points K21 to K28 located around the distance measurement point K11.

The coordinate correction unit 32 executes the positional deviation correction processing by using nearby distance measurement points of M×M centered on the distance measurement point of interest K11. In the example of FIG. 7, assuming M=3, the positional deviation correction processing is executed using the eight distance measurement points K21 to K28 around the distance measurement point of interest K11. Here, a position (position vector) of the distance measurement point K11 in the enlarged region 61 is defined as a position “a”. Furthermore, positions (position vectors) of the eight distance measurement points K21 to K28 are defined as positions b1 to b8, respectively.

Note that, in FIG. 7, a histogram displayed near the nine distance measurement points which are the distance measurement point K11 and the distance measurement points K21 to K28 conceptually illustrates the distance histogram of each distance measurement point, and is not a part of the RGB image 51.

The enlarged region 61 includes an edge 62, and is sectioned into a region 63 of the car 41 and a region 64 of the background 44, with the edge 62 as a boundary. Furthermore, a region having a predetermined width from the edge 62 is an edge region 65.

The coordinate correction unit 32 calculates a vector (e-a) from the position “a” of the distance measurement point of interest K11 to a nearest position “e” of the edge 62 in a screen coordinate system of the RGB image 51.

The coordinate correction unit 32 calculates similarity of the distance histogram between the distance measurement point of interest K11 and a plurality of nearby distance measurement points, and calculates a centroid vector of the similarity. In this example, an example will be described in which the coordinate correction unit 32 uses nine distance measurement points of 3×3 centered on the distance measurement point of interest K11 to calculate similarity between the distance measurement point of interest K11 and the eight surrounding distance measurement points K21 to K28, and calculates a centroid vector of the similarity.

The distance histogram includes not only single piece of distance information of the distance measurement point but also additional information such as reflectance of an object and disturbance light serving as a clue for determining a correspondence relationship with a surrounding distance measurement point and a correspondence relationship between adjacent frames. By comparing the distance histograms, for example, the following information can be used in calculating the similarity.
Movement along a distance attenuation line (a distance change of the same subject)
Appearance of other peaks due to an object boundary or a transparent subject such as glass
Distortion of a histogram waveform due to internal scattering
Disturbance light (a light source direction is detected, and shadow edge information can be used)
Interchange of a histogram waveform generated at an object boundary

In the present embodiment, an example of (1) using correlation of distance histograms and an example of (2) using a distance in a manifold space will be described as examples of similarity calculation between distance histograms.

First, a similarity calculation method in a case where the similarity is calculated by (1) using correlation of distance histograms will be described.

When a distance histogram Hₐ of the distance measurement point of interest K11 includes N bins and has a count value of an i-th bin of Cₐᵢ (i=1, 2, 3, . . . , N), the distance histogram Hₐ is expressed by Hₐ={Cₐ₁, Cₐ₂, . . . , C_{aN}}. Furthermore, when a distance histogram H_{b} of one predetermined distance measurement point K2b among the distance measurement points K21 to K28 near the distance measurement point of interest K11 includes N bins, and has a count value of an i-th bin of C_{bi} (i=1, 2, 3, . . . , N), the distance histogram H_{b} is expressed by H_{b}={C_{b1}, C_{b2}, . . . , C_{bN}}.

At this time, similarity r_{ab} between the distance histogram Hₐ and the distance histogram H_{b} can be expressed by the following Formula (1).

$$\begin{matrix}[ Equation 1 ] & \\ {r}_{ab} = \frac{\frac{1}{N} {\sum }_{i = 1}^{N} ( {C}_{ai} - \overline{{C}_{a \_ av}} ) ( {C}_{bi} - \overline{{C}_{b \_ av}} )}{\sqrt{\frac{1}{N} {\sum }_{i = 1}^{N} ( {C}_{ai} - \overline{{C}_{a \_ av}} )} * \sqrt{\frac{1}{N} {\sum }_{i = 1}^{N} ( {C}_{bi} - \overline{{C}_{b \_ av}} )}} & ( 1 )\end{matrix}$$

C_{a_av} in Formula (1) represents C_{a_av}=AVE (Cₐ₁, Cₐ₂, . . . , C_{aN}), that is, an average value of N count values Cₐ₁, Cₐ₂, . . . , C_{aN} of the distance histogram Hₐ. Similarly, C_{b_av} represents C_{b_av}=AVE (C_{b1}, C_{b2}, . . . , C_{bN}), that is, an average value of N count values C_{b1}, C_{b2}, . . . , C_{bN} of the distance histogram H_{b}. In Formula (1), r_{ab} corresponds to a correlation coefficient between the distance histogram Hₐ and the distance histogram H_{b}.

A similarity vector Vr_{ab} between the distance measurement point of interest K11 and the nearby distance measurement point K2b can be expressed by the following Formula (2) by using the similarity r_{ab} of Formula (1).

$$\begin{matrix}[ Equation 2 ] & \\ v {r}_{ab} = \frac{{r}_{ab} ( b - a )}{\vert b - a \vert} & ( 2 )\end{matrix}$$

In Formula (2), “a” is a position vector of the distance measurement point K11, and “b” is a position vector of the distance measurement point K2b. Therefore, the similarity vector Vr_{ab} between the distance measurement point of interest K11 and the nearby distance measurement point K2b is obtained by multiplying a vector difference between the position vector “a” of the distance measurement point of interest K11 and the position vector “b” of the distance measurement point K2b by the similarity (correlation coefficient) r_{ab} between the position vector “a” and the position vector “b”.

For all of the eight distance measurement points K21 to K28 near the distance measurement point of interest K11, the similarity vector Vr_{ab} of Formula (2) is calculated and expressed as a similarity vector Vr_{abi} (i=1, 2, . . . , 8).

A centroid vector “r” of the similarity vector Vr_{abi} (i=1, 2, . . . , 8) of the distance measurement point of interest K11 and the nearby eight distance measurement points K21 to K28 is expressed by the following Formula (3).

$$\begin{matrix}[ Equation 3 ] & \\ r = \frac{{M}^{2} - 1}{2} {\sum }_{i = 1}^{{M}^{{2}_{- 1}}} v {r}_{abi} & ( 3 )\end{matrix}$$

M in Formula (3) is M²−1=8 because M=3 in the example of FIG. 7.

FIG. 7 illustrates the centroid vector “r” of similarity vectors Vr_{ab1} to Vr_{ab8} of the eight distance measurement points K21 to K28 near the distance measurement point of interest K11.

Next, the coordinate correction unit 32 calculates an angle θ formed by the centroid vector “r” of the similarity vectors Vr_{ab1} to Vr_{ab8} of the eight distance measurement points K21 to K28 near the distance measurement point of interest K11 and the vector (e-a) from the position “a” of the distance measurement point of interest K11 toward the nearest position “e” of the edge 62.

In a case where the angle θ formed by the centroid vector “r” and the vector (e-a) is within a predetermined threshold value, for example, in a case where −π/2<θ<π/2, the coordinate correction unit 32 determines that directions of the two vectors match. Conversely, in a case where the angle θ formed by the centroid vector “r” and the vector (e-a) is larger than the predetermined threshold value, the coordinate correction unit 32 determines that the directions of the two vectors do not match.

In a case where the directions of the two vectors match, the coordinate correction unit 32 determines that the distance measurement point of interest K11 needs to be corrected, and moves (corrects) the position “a” of the distance measurement point of interest K11 such that the distance measurement point of interest K11 crosses the edge 62. For example, the coordinate correction unit 32 moves (corrects) the position “a” of the distance measurement point of interest K11 to the position “a′” in FIG. 7 calculated by a′=a+2 (e-a). Conversely, in a case where the directions of the two vectors do not match, it is determined that the correction of the distance measurement point of interest K11 is unnecessary, and the position “a” of the distance measurement point of interest K11 is not moved (corrected).

As described above, it is possible to calculate the centroid vector “r” from the similarity vector vr_{ab} calculated by (1) using correlation of distance histograms, determine whether or not to correct the position “a” of the distance measurement point of interest K11, and correct the positional deviation of the distance measurement point of interest.

Next, a description is given to a similarity calculation method in a case where similarity is calculated by (2) using a distance in a manifold space.

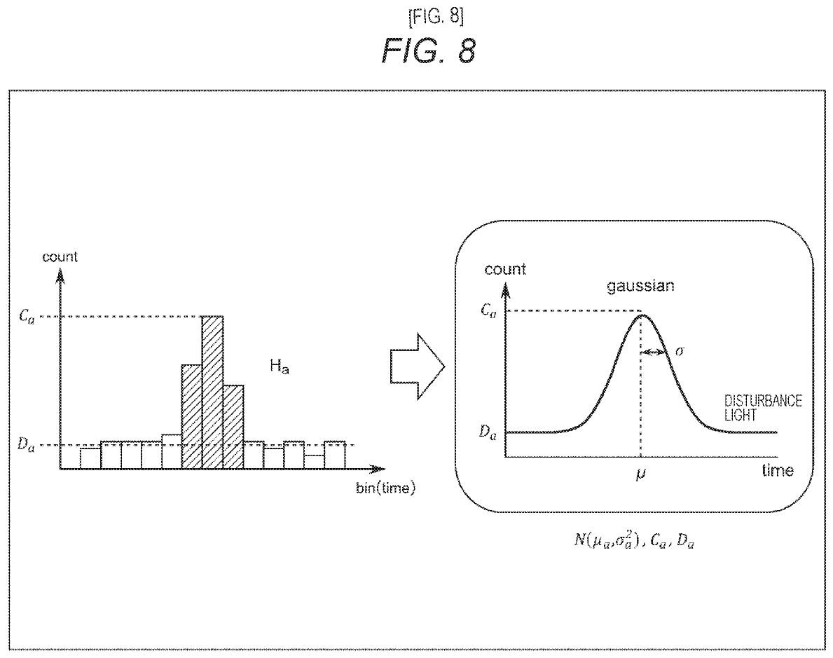

As illustrated in FIG. 8, the coordinate correction unit 32 calculates a peak count value Cₐ of the distance histogram Hₐ of the distance measurement point of interest K11 and a count value (a median value) Dₐ of disturbance light. Then, the coordinate correction unit 32 normalizes a count value of each bin of the distance histogram Hₐ by dividing the count value by a total count value, converts the count value into a probability density function, and then performs Gaussian fitting (Gaussian function approximation) on the distance histogram Hₐ. For example, it is assumed that the distance histogram Hₐ of the distance measurement point of interest K11 is approximated to a normal distribution N (μₐ, σₐ²) of an average μₐ and a variance σₐ².

The coordinate correction unit 32 similarly calculates a peak count value C_{b} and a count value D_{b} of disturbance light and performs Gaussian fitting, on the distance histogram H_{b} of one predetermined distance measurement point K2b among the distance measurement points K21 to K28 near the distance measurement point of interest K11. It is assumed that the distance histogram H_{b} is approximated to, for example, a normal distribution N (μ_{b}, σ_{b}²) of an average μ_{b} and a variance σ_{b}².

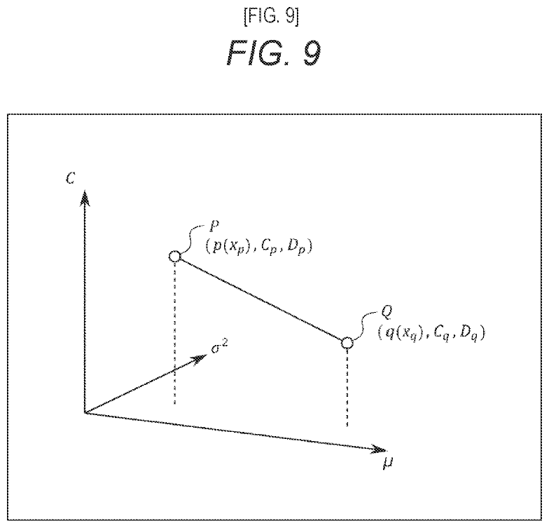

Next, as illustrated in FIG. 9, the coordinate correction unit 32 maps the distance measurement point of interest K11 and the nearby distance measurement point K2b on the non-Euclidean space in which an x axis is an average μ, a y axis is a variance σ², and a z axis is a peak count value C. A point P in the non-Euclidean space in FIG. 9 corresponds to the distance measurement point of interest K11, and p (Xₚ)=N (μₐ, σₐ²), Cₚ=Cₐ, and Dₚ=Dₐ are satisfied. A point Q corresponds to the distance measurement point of interest K2b, and p (x_{q})=N (μ_{b}, σ_{b}²), C_{q}=C_{b}, and D_{q}=D_{b} are satisfied.

Next, the coordinate correction unit 32 calculates a pseudo distance L between the point P and the point Q on the non-Euclidean space corresponding to the distance measurement point of interest K11 and the distance measurement point K2b, by using the following Formula (4).

$$\begin{matrix}[ Equation 4 ] & \\ L = a ( KL ( p \vert \vert q ) ) + b \vert {C}_{p} - {C}_{q} \vert + c \vert {D}_{p} - {D}_{q} \vert & ( 4 )\end{matrix}$$

In Formula (4), KL (p∥q) represents KL divergence between two normal distributions of the points P and Q. |Cₚ-C_{q}| is a difference between peak count values Cₚ and C_{q} of the points P and Q according to an L1 norm, and |Dₚ-D_{q}| is a difference between count values Dₚ and D_{q} of disturbance light of the points P and Q according to the L1 norm. Furthermore, “a”, “b”, and “c” are coefficients representing individual weights, and can be freely set in a range of 0 to 1.

That is, the pseudo distance L between the point P and the point Q on the non-Euclidean space corresponding to the distance measurement point of interest K11 and the distance measurement point K2b is calculated by a weighted sum of the KL divergence between the two points P and Q, the difference between the peak count values Cₚ and C_{q}, and the difference between the count values Dₚ and D_{q} of the disturbance light.

Next, the coordinate correction unit 32 calculates the similarity vector vr_{ab} of the distance measurement point of interest K11 and the nearby distance measurement point K2b, by using the following Formula (5) using the pseudo distance L.

$$v {r}_{a b} = 1 - ( 1 / L ) \qquad ( 5 )$$

Processing thereafter is similar to the case of using correlation of distance histograms. That is, for all of the eight distance measurement points K21 to K28 near the distance measurement point of interest K11, the similarity vector vr_{ab} of Formula (5) is calculated, and the similarity vector vr_{abi} (i=1, 2, . . . , 8) is calculated. Then, the centroid vector “r” is calculated by using the above-described Formula (3), and the position “a” of the distance measurement point of interest K11 is moved (corrected) in accordance with whether or not the angle θ formed by the centroid vector “r” and the vector (e-a) is within a predetermined threshold value.

In a case of calculating similarity by using a distance in a manifold space described above, a data amount can be suppressed as compared with the case of using correlation of distance histograms.

In the example described above, assuming M=3, determination has been made as to whether or not to correct the distance measurement point of interest K11 by using the eight distance measurement points K21 to K28 near the distance measurement point of interest K11. However, it goes without saying that the number of nearby distance measurement points can be freely set.

### 4. Position Information Calculation Processing According to First Embodiment

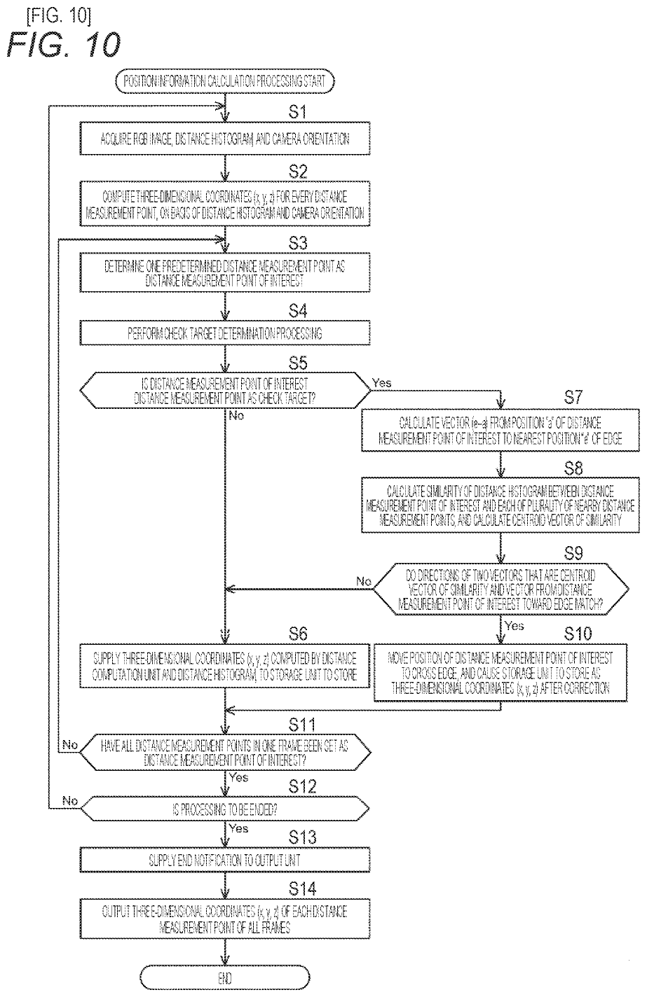

Next, with reference to a flowchart of FIG. 10, position information calculation processing performed by the signal processing system 1 according to the first embodiment will be described. This processing is started, for example, when an RGB image and a distance histogram are supplied from the RGB camera 11 and the dToF sensor 12.

Note that, in the position information calculation processing of FIG. 10, an example of the case of (1) using correlation of distance histograms will be described as a method of calculating similarity between the distance histograms by the coordinate correction unit 32.

First, in step S1, the data acquisition unit 21 acquires the RGB image supplied from the RGB camera 11 and the distance histogram and the camera orientation supplied from the dToF sensor 12. The data acquisition unit 21 supplies the acquired RGB image to the correction processing unit 23, and supplies the acquired distance histogram and camera orientation to the distance computation unit 22.

In step S2, the distance computation unit 22 computes three-dimensional coordinates (x, y, z) for every distance measurement point on the basis of the distance histogram and the camera orientation from the data acquisition unit 21. More specifically, the distance computation unit 22 detects a peak region of a count value from histogram data of the multipixel MP corresponding to the spot light SP, and computes three-dimensional coordinates (x, y, z) from the detected peak region and the camera orientation. The computed three-dimensional coordinates (x, y, z) of each distance measurement point are supplied to the correction processing unit 23 together with the distance histogram.

In step S3, the correction processing unit 23 determines a predetermined one of distance measurement points included in one frame supplied from the dToF sensor 12 as the distance measurement point of interest, and the processing proceeds to step S4.

In step S4, the check target determination unit 31 of the correction processing unit 23 executes the check target determination processing. For example, the check target determination unit 31 determines an edge region by detecting an edge of the RGB image 51 and performing the expansion processing, and determines whether or not the distance measurement point of interest is a distance measurement point as a check target, on the basis of whether or not screen coordinates (u, v) of the distance measurement point of interest on the RGB image 51 are included in the edge region.

In step S5, the check target determination unit 31 determines whether the distance measurement point of interest is a distance measurement point as a check target, on the basis of a result of the check target determination processing. When it is determined in step S5 that the distance measurement point of interest is not a distance measurement point as a check target, the processing proceeds to step S6. When it is determined that the distance measurement point of interest is a distance measurement point as a check target, the processing proceeds to step S7.

In step S6 in a case where it has been determined that the distance measurement point of interest is not a distance measurement point as a check target, the check target determination unit 31 supplies the three-dimensional coordinates (x, y, z) of the distance measurement point of interest computed by the distance computation unit 22 and the distance histogram as they are, to the storage unit 24 to store. The RGB image supplied from the data acquisition unit 21 is also supplied to and stored in the storage unit 24.

Whereas, in step S7 in a case where it has been determined that the distance measurement point of interest is a distance measurement point as a check target, the coordinate correction unit 32 calculates the vector (e-a) from the position “a” of the distance measurement point of interest to the nearest position “e” of the edge 62, in the screen coordinate system of the RGB image 51.

In step S8, the coordinate correction unit 32 calculates similarity (a similarity vector) of the distance histogram between the distance measurement point of interest and each of the plurality of nearby distance measurement points, and calculates a centroid vector of the similarity. For example, by using nine distance measurement points of 3×3 centered on the distance measurement point of interest K11, the similarity vectors Vr_{ab1} to Vr_{ab8} of the distance histograms of the distance measurement point of interest K1l and the eight surrounding distance measurement points K21 to K28 are calculated, and the centroid vector “r” of the similarity vectors Vr_{ab1} to Vr_{ab}& of Formula (3) is calculated.

In step S9, the coordinate correction unit 32 determines whether directions of two vectors match, that is, the centroid vector “r” of the similarity of the plurality of nearby distance measurement points near the distance measurement point of interest and the vector (e-a) from the distance measurement point of interest toward the nearest position “e” of the edge 62 match. In step S9, for example, when the angle θ formed by the centroid vector “r” and the vector (e-a) is within a predetermined threshold value, it is determined that the directions of the two vectors match. When the angle θ is equal to or greater than the predetermined threshold value, it is determined that the directions of the two vectors do not match.

When it is determined in step S9 that the directions of the two vectors do not match, the processing proceeds to step S6 described above. Therefore, in this case, the three-dimensional coordinates (x, y, z) of the distance measurement point of interest are not corrected, and are stored in the storage unit 24 as they are.

Whereas, when it is determined in step S9 that the directions of the two vectors match, the processing proceeds to step S10. In step S10, the coordinate correction unit 32 moves the position “a” of the distance measurement point of interest such that the distance measurement point of interest crosses the edge 62, and causes the storage unit 24 to store the three-dimensional coordinates (x, y, z) after the movement, as the three-dimensional coordinates (x, y, z) after correction. The distance histogram of the distance measurement point of interest and the RGB image supplied from the data acquisition unit 21 are also supplied to and stored in the storage unit 24.

After step S6 or S10, in step S11, the correction processing unit 23 determines whether all the distance measurement points in one frame supplied from the dToF sensor 12 have been set as the distance measurement point of interest. When it is determined in step S11 that all the distance measurement points of one frame have not been set as the distance measurement point of interest yet, the processing returns to step S3, and steps S3 to S11 described above are repeated. That is, among the distance measurement points of one frame, a distance measurement point that has not yet been set as the distance measurement point of interest is set as the next distance measurement point of interest, and determination is made as to whether or not the distance measurement point is a distance measurement point as a check target. Then, when it is determined that the directions of the two vectors match, the three-dimensional coordinates (x, y, z) of the distance measurement point of interest are corrected (moved).

Whereas, when it is determined in step S11 that all the distance measurement points in one frame have been set as the distance measurement point of interest, the processing proceeds to step S12, and the signal processing apparatus 13 determines whether or not to end the processing. For example, the processing of steps S1 to S11 described above is executed for the distance measurement points of all the frames supplied from the dToF sensor 12, and the signal processing apparatus 13 determines to end the processing when the distance histogram of the next frame is not supplied from the dToF sensor 12. On the contrary, when the distance diagram of the next frame is supplied from the dToF sensor 12, the signal processing apparatus 13 determines not to end the processing.

When it is determined in step S12 that the processing is not to be ended yet, the processing returns to step S1, and the processing of steps S1 to S12 described above is repeated.

Whereas, when it is determined in step S12 that the processing is to be ended, the processing proceeds to step S13, and the correction processing unit 23 supplies an end notification to the output unit 25.

In step S14, the output unit 25 outputs the three-dimensional coordinates (x, y, z) of each distance measurement point of all the frames stored in the storage unit 24, and ends the position information calculation processing in FIG. 10. The output three-dimensional coordinates (x, y, z) of each distance measurement point of each frame include those subjected to the correction processing and those not subjected to the correction processing.

According to the position information calculation processing of the signal processing system 1 according to the first embodiment described above, it is determined whether or not the distance measurement point of interest is a distance measurement point as a check target, on the basis of whether or not the distance measurement point of interest is included in the edge region. Then, when it is determined that the distance measurement point of interest is a distance measurement point as a check target, the position of the distance measurement point of interest is corrected toward a nearby distance measurement point having a similar distance histogram, by calculating the similarity (the similarity vector) between the distance histogram of the distance measurement point of interest and the distance histograms of a plurality of nearby distance measurement points. As a result, it is possible to correct a deviation of position information of the dToF sensor 12.

### 5. Second Embodiment of Signal Processing System

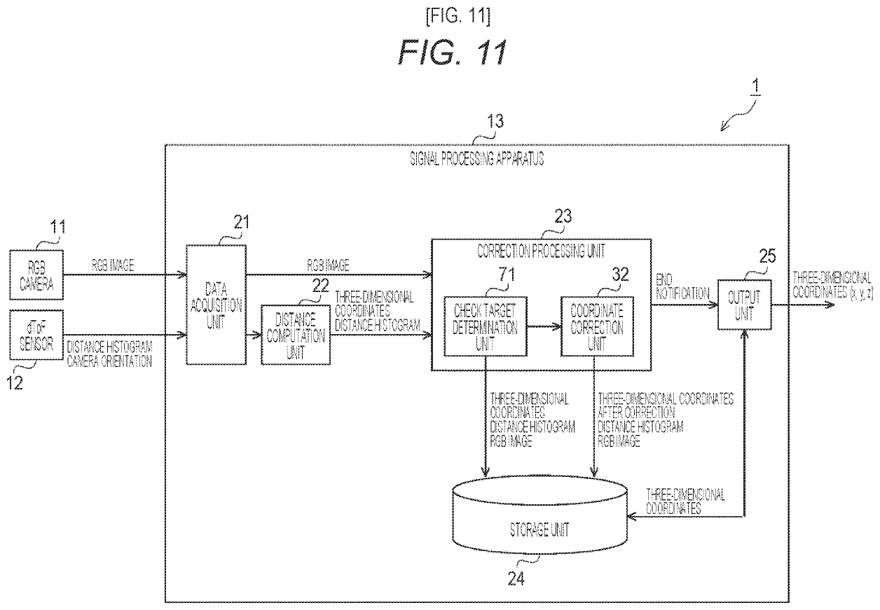

FIG. 11 is a block diagram illustrating a configuration example of a second embodiment of a signal processing system of the present disclosure.

In the second embodiment of FIG. 11, parts corresponding to those of the first embodiment illustrated in FIG. 1 are denoted by the same reference numerals, and a description of the parts will be omitted as appropriate.

A signal processing system 1 according to the second embodiment includes an RGB camera 11, a dToF sensor 12, and a signal processing apparatus 13. The signal processing apparatus 13 includes a data acquisition unit 21, a distance computation unit 22, a correction processing unit 23, a storage unit 24, and an output unit 25, and the correction processing unit 23 includes a check target determination unit 71 and a coordinate correction unit 32.

That is, in the signal processing system 1 according to the second embodiment, the check target determination unit 31 of the correction processing unit 23 in the first embodiment is changed to the check target determination unit 71, and other configurations are similar to those of the first embodiment. In other words, the second embodiment is different from the first embodiment in a determination method of determining whether or not a distance measurement point of interest is a distance measurement point as a check target, and is similar to the first embodiment in other points.

In the first embodiment described above, an edge region is extracted from an RGB image as a region near an object boundary, and whether or not the distance measurement point is a distance measurement point in which a positional deviation has highly possibly occurred is determined on the basis of whether or not the distance measurement point of interest is included in the edge region. On the other hand, the check target determination unit 71 according to the second embodiment observes a change in a distance histogram over a plurality of frames, to determine whether the distance measurement point of interest is a region near the object boundary. Then, when it is determined that the distance measurement point of interest is a region near the object boundary, the check target determination unit 71 regards as a distance measurement point in which a positional deviation has highly possibly occurred, and determines that the distance measurement point of interest is a distance measurement point as a check target.

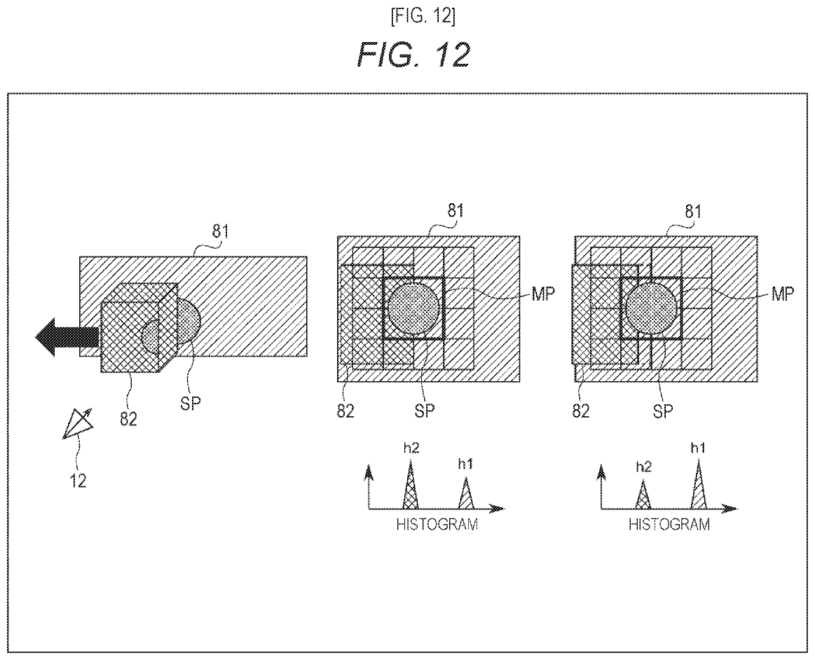

For example, as illustrated in FIG. 12, a case will be considered in which an object 81 on a background side and an object 82 on a foreground side are present as subjects, and a boundary portion between the object 81 and the object 82 is irradiated with spot light SP. It is assumed that the object 82 on the foreground side is a moving subject and moves in a left direction indicated by an arrow.

The distance histogram output by the dToF sensor 12 includes two peak regions of a peak region h1 corresponding to the object 81 and a peak region h2 corresponding to the object 82. In a case where a region where the spot light SP hits on the object 82 is larger than a region where the spot light SP hits on the object 81, a peak count value of the peak region h2 corresponding to the object 82 is larger than a peak count value of the peak region h1 corresponding to the object 81. Thereafter, when the region where the spot light SP hits on the object 81 becomes larger than the region where the spot light SP hits on the object 82 due to the movement of the object 82, the peak count value of the peak region h1 corresponding to the object 81 becomes larger than the peak count value of the peak region h2 corresponding to the object 82. Furthermore, although not illustrated, in a case where only one of the object 81 and the object 82 is irradiated with the spot light SP rather than the boundary portion between the object 81 and the object 82, the distance histogram output by the dToF sensor 12 is a histogram having one peak region having a large peak count value.

Therefore, the check target determination unit 71 observes the distance histogram over a plurality of frames and determines that the distance measurement point at which the number of peak regions on the distance histogram changes such that “1→2→1” is a distance measurement point as a check target. Note that, in the distance measurement point at which the number of peak regions changes such that “1→2→1”, there may be a change such as “background-boundary portion between foreground and background-foreground” and a change such as “foreground-boundary portion between foreground and background-background”.

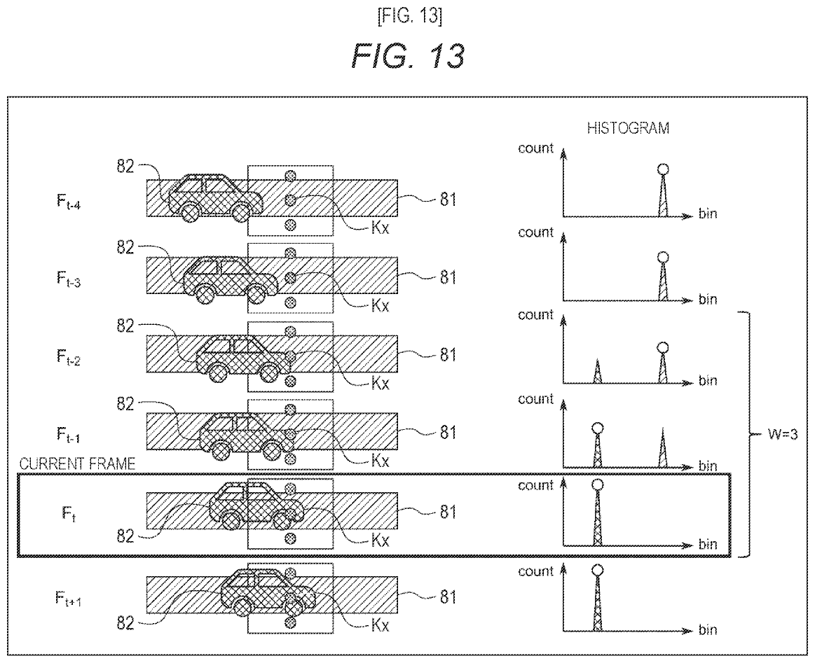

FIG. 13 is a view for explaining check target determination processing performed by the check target determination unit 71.

First, the check target determination unit 71 determines whether the number of peak regions in a distance histogram of a distance measurement point of interest Kx in a frame Ft at a current time t is one or two or more. In a case where the number of peak regions in the distance histogram of the distance measurement point of interest Kx is two or more, it is regarded that the distance measurement point has a possibility of being an object boundary and a positional deviation has highly possibly occurred in the distance measurement point, and the distance measurement point of interest is determined to be a distance measurement point as a check target.

Whereas, in a case where the number of peak regions in the distance histogram of the distance measurement point of interest Kx is one, the distance histogram of the distance measurement points Kx at the same position in past W frames (W is an integer of 2 or more) is acquired from the storage unit 24, and the number of peak regions in the distance histogram in the past W frames and a bin position with a largest count value are checked. In a case where the number of peak regions in the distance histogram in the past W frames is one, and the bin position with the largest count value is also the same, the check target determination unit 71 regards as the distance measurement point having a low possibility of a positional deviation, and determines that the distance measurement point of interest is not a distance measurement point as a check target.

Whereas, in a case where the number of peak regions in the distance histogram in the past W frames is two or more and the bin position with the largest count value has been changed, the check target determination unit 71 regards as a distance measurement point in which a positional deviation has highly possibly occurred, and determines that the distance measurement point of interest is a distance measurement point as a check target.

In the example of FIG. 13, the number of peak regions in the distance histogram of the distance measurement point of interest Kx in the frame Ft at the current time t is one. Therefore, the distance histogram of the distance measurement point Kx at the same position in the past W frames is acquired from the storage unit 24, and the number of peak regions in the distance histogram in the past W frames and the bin position with the largest count value are checked.

Here, assuming W=3 and that the number of peak regions in the distance histogram and the bin position with the largest count value in the past three frames are to be checked, the number of peak regions of a frame Ft-1 at a time t-1 and a frame Ft-2 at a time t-2 is two, and the bin position with the largest count value changes between the frame Ft-2 at the time t-2 and the frame Ft-1 at time t-1. In the distance histogram of each frame illustrated in FIG. 13, a circle is given to a peak with the largest count value.

Therefore, the check target determination unit 71 determines that the distance measurement point of interest Kx in the frame Ft at the current time t is a distance measurement point in which a positional deviation has highly possibly occurred and is a distance measurement point as a check target.

Note that, in the second embodiment, as described above, by observing the change in the distance histogram over the past W frames, determination is made as to whether the distance measurement point of interest is a region near an object boundary and as to whether or not the distance measurement point is a distance measurement point as a check target. Therefore, a position of each multipixel MP of the dToF sensor 12 does not change in all frames during an image-capturing period, and it is necessary to perform sampling at the same position in each frame.

### 6. Position Information Calculation Processing According to Second Embodiment

In position information calculation processing performed by the signal processing system 1 according to the second embodiment, the determination method of the check target determination processing performed in step S4 of the flowchart of FIG. 10 described in the first embodiment is different, and the other processing of steps S1 to S3 and steps S5 to S14 are the same.

Describing with reference to the flowchart of FIG. 10, in step S4 of FIG. 10, the check target determination unit 71 determines whether the number of peak regions in a distance histogram of the distance measurement point of interest Kx in the frame Ft at the current time t is one or two or more. Then, in a case where the number of peak regions in the distance histogram of the distance measurement point of interest Kx is two or more, the check target determination unit 71 determines that the distance measurement point of interest is a distance measurement point as a check target.

Whereas, in a case where the number of peak regions in the distance histogram of the distance measurement point of interest Kx in the frame Ft at the current time t is one, the check target determination unit 71 further checks the number of peak regions in the distance histogram in the past W frames and the bin position with the largest count value. In a case where the number of peak regions in the distance histogram in the past W frames is one and the bin position with the largest count value is also the same, the check target determination unit 71 determines that the distance measurement point of interest Kx is not a distance measurement point as a check target. Whereas, in a case where the number of peak regions in the distance histogram in the past W frames is two and the bin position with the largest count value is also interchanged, the check target determination unit 71 determines that the distance measurement point of interest Kx is a distance measurement point as a check target.

According to the position information calculation processing of the signal processing system 1 according to the second embodiment described above, determination is made as to whether or not the distance measurement point of interest is a distance measurement point as a check target, on the basis of whether or not the number of peak regions in the distance histogram of the distance measurement point of interest and the bin position with the largest count value have changed in the past W frames. Then, when it is determined that the distance measurement point of interest is a distance measurement point as a check target, the position of the distance measurement point of interest is corrected toward a nearby distance measurement point having a similar distance histogram, by calculating the similarity (the similarity vector) between the distance histogram of the distance measurement point of interest and the distance histograms of a plurality of nearby distance measurement points. As a result, it is possible to correct a deviation of position information of the dToF sensor 12.

Note that, in the second embodiment, in a case where the RGB camera 11 and the dToF sensor 12 have fixed positions and capture an image of a subject, a distance measurement point at which the number of peak regions in the distance histogram changes such that “1→2→1” is a point at which an image of a moving subject has been captured, and reliability of the calculated three-dimensional coordinates is expected to be low. Therefore, in a case where the positions of the RGB camera 11 and the dToF sensor 12 are fixed, in the distance measurement points at which the number of peak regions in the distance histogram changes such as “1→2→1”, measured values of the three-dimensional coordinates may be deleted and not output from the signal processing apparatus 13.

Alternatively, reliability may be added to the distance measurement point at which the number of peak regions in the distance histogram changes such that “1→2→1”, and the distance measurement point may be output to enable a device on a subsequent stage to identify as the distance measurement point having the low reliability. The reliability of the distance measurement point can be obtained by, for example, a value obtained by subtracting a reciprocal of the number of frames related to interchange of the peak of the distance histogram from 1, such as the number of peak regions in the distance histogram “1→2→1”, “1→2→2→1”, or “1→2→2→2→1”. Specifically, for example, the reliability of the distance measurement point at which the number of peak regions in the distance histogram changes such that “1→2→1” can be calculated as “1−⅓=0.6”. Furthermore, for example, the reliability of the distance measurement point at which the number of peak regions in the distance histogram changes such that “1→2→2→1” can be calculated as “1−¼=0.75”. Furthermore, for example, the reliability of the distance measurement point at which the number of peak regions in the distance histogram changes such that “1→2→2→2→1” can be calculated as “1−⅕=0.8”.

The device on the subsequent stage that has acquired the distance measurement point to which the reliability is added can perform, for example, processing of preventing afterimage, by recognizing as the distance measurement point with low reliability.

### 7. Conclusion

The signal processing apparatus 13 includes: the data acquisition unit 21 configured to acquire a distance histogram that is histogram data of time of flight of irradiation light at a predetermined distance measurement point of a distance measurement sensor; the distance computation unit 22 configured to compute three-dimensional coordinates of the predetermined distance measurement point from the distance histogram of the predetermined distance measurement point; the check target determination unit 31 configured to determine whether or not the predetermined distance measurement point is a distance measurement point as a positional deviation check target; and the coordinate correction unit 32 configured to execute positional deviation correction processing of correcting the three-dimensional coordinates of the predetermined distance measurement point computed by the distance computation unit 22, on the basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.

The check target determination unit 31 according to the first embodiment detects an edge region of an object from an RGB image (captured image) obtained by capturing an image of a subject by the RGB camera 11, and determines that the distance measurement point is a distance measurement point as a check target in which a positional deviation has highly possibly occurred, in a case where the predetermined distance measurement point is included in the edge region.

Whereas, the check target determination unit 31 according to the second embodiment determines whether or not a predetermined distance measurement point is a distance measurement point as a positional deviation check target, by observing a change in a distance histogram of the distance measurement point over a plurality of frames. For example, in a case where the number of peak regions in the distance histogram has changed such that “1→2→1”, and a bin position with the largest count value has changed, the check target determination unit 31 determines that the distance measurement point is a distance measurement point as a check target.

In a case where a centroid vector of similarity between the distance histogram of a distance measurement point as a check target and the distance histogram of a nearby distance measurement point near the distance measurement point coincides with a direction of an object boundary, the coordinate correction unit 32 determines that the three-dimensional coordinates of the distance measurement point need to be corrected, and corrects (moves) the three-dimensional coordinates of the distance measurement point.

According to the check target determination processing and the positional deviation correction processing described above of the signal processing apparatus 13, it is possible to correct a deviation of position information of the dToF sensor 12 in a correct direction.

The signal processing apparatus 13 may have the configuration and the function of only one of the first embodiment and the second embodiment described above, or may have both configurations and functions and selectively perform, for example, either one of a first operation mode corresponding to the first embodiment and a second operation mode corresponding to the second embodiment by switching.

### Application Example of Present Technology

The position information calculation processing of the present disclosure capable of correcting and outputting three-dimensional coordinates by using histogram data acquired from the dToF sensor 12 can be applied to three-dimensional measurement of various applications such as simultaneous localization and mapping (SLAM) that simultaneously performs self-localization and environmental mapping, a robot operation of holding an object and performing movement and work, CG modeling in a case of generating a virtual scene or object by computer graphics (CG), and object recognition processing and object classification processing. By applying the correction processing of the present disclosure, measurement accuracy of three-dimensional coordinates of an object can be improved.

### 8. Computer Configuration Example

The above-described series of processing can be performed by hardware or software. In a case where the series of processing is executed by the software, a program that configures the software is installed in a computer. Here, examples of the computer include, for example, a microcomputer that is built in dedicated hardware, a general-purpose personal computer that can perform various functions by being installed with various programs, and the like.

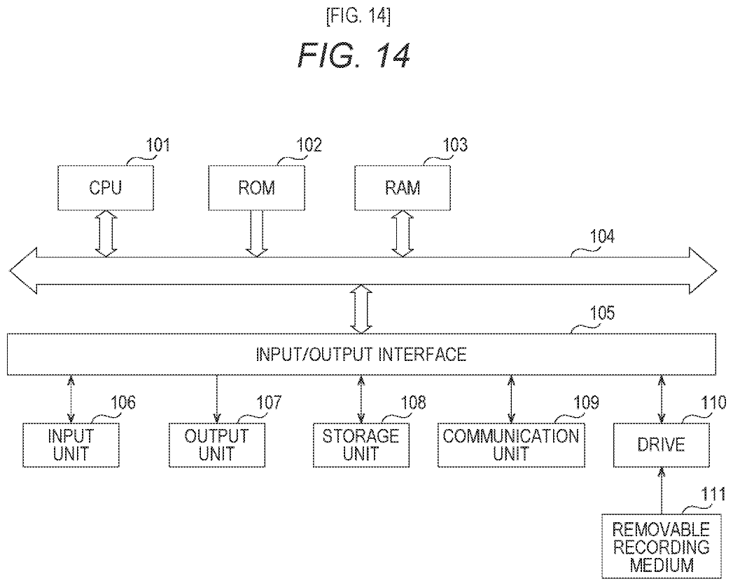

FIG. 14 is a block diagram illustrating a configuration example of hardware of a computer that executes the above-described series of processing by a program.

In the computer, a central processing unit (CPU) 101, a read only memory (ROM) 102, and a random access memory (RAM) 103 are mutually connected by a bus 104.

The bus 104 is further connected with an input/output interface 105. An input unit 106, an output unit 107, a storage unit 108, a communication unit 109, and a drive 110 are connected to the input/output interface 105.

The input unit 106 includes a keyboard, a mouse, a microphone, a touch panel, an input terminal, and the like. The output unit 107 includes a display, a speaker, an output terminal, and the like. The storage unit 108 includes a hard disk, a RAM disk, a non-volatile memory, or the like. The communication unit 109 includes a network interface and the like. The drive 110 drives a removable recording medium 111 such as a magnetic disk, an optical disk, a magneto-optical disk, or a semiconductor memory.

In the computer configured as described above, for example, the CPU 101 loads the program stored in the storage unit 108 into the RAM 103 via the input/output interface 105 and the bus 104 and executes the program, thereby performing the series of the position information calculation processing described above. As appropriate, the RAM 103 also stores data necessary for the CPU 101 to execute various kinds of processing.

The program executed by the computer (CPU 101) can be provided by recording on the removable recording medium 111 as a package medium and the like, for example. Furthermore, the program can be provided via a wired or wireless transmission medium such as a local area network, the Internet, or digital satellite broadcasting.

In the computer, the removable recording medium 111 is set in the drive 110, so that the program can be installed into the storage unit 108 via the input/output interface 105. Furthermore, the program can be received by the communication unit 109 via the wired or wireless transmission medium and installed on the storage unit 108. Furthermore, the program can be installed on the ROM 102 or the storage unit 108 in advance.

Note that the program executed by the computer may be a program that performs processing in a time-series manner in the order described in the present specification, or may be a program that performs processing in parallel or at necessary timing such as when a call is made.

In the present description, a system is intended to mean assembly of a plurality of constituent elements (apparatuses, modules (parts), and the like), and it does not matter whether or not all the constituent elements are located in the same housing. Therefore, a plurality of devices housed in separate housings and coupled via a network and one device in which a plurality of modules is housed in one housing are both systems.

Furthermore, the embodiment of the present disclosure is not limited to the above-described embodiments and various modifications may be made without departing from the gist of the technology of the present disclosure.

Note that, the effects described in the present specification are merely examples and are not limited, and there may be effects other than those described in the present specification.

Note that the technique of the present disclosure can have the following configurations.

(1)

A signal processing apparatus including:
an acquisition unit configured to acquire a distance histogram that is histogram data of time of flight of irradiation light at a predetermined distance measurement point of a distance measurement sensor;
a determination unit configured to determine whether or not the predetermined distance measurement point is a distance measurement point as a positional deviation check target; and
a correction unit configured to execute correction processing of correcting three-dimensional coordinates of the predetermined distance measurement point, the three-dimensional coordinates being computed from the distance histogram, on the basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.
   (2)

The signal processing apparatus according to (1) above, in which
the correction unit executes the correction processing in a case where it is determined that a centroid vector of similarity between the distance histogram of the predetermined distance measurement point and the distance histogram of a nearby distance measurement point near the predetermined distance measurement point coincides with a direction of an object boundary.
   (3)

The signal processing apparatus according to (2) above, in which
in a case where it is determined that the centroid vector of the similarity coincides with a direction of an object boundary, the correction unit corrects three-dimensional coordinates of the predetermined distance measurement point to a position across the object boundary.
   (4)

The signal processing apparatus according to (2) above, in which
from the similarity between the distance histogram of the predetermined distance measurement point and the distance histogram of each of a plurality of nearby distance measurement points near the predetermined distance measurement point, the correction unit calculates the centroid vector of the similarity.
   (5)

The signal processing apparatus according to (4) above, in which
the correction unit calculates similarity between the distance histogram of the predetermined distance measurement point and the distance histogram of one of the nearby distance measurement points, on the basis of a difference between a position vector of the predetermined distance measurement point and a position vector of the one of the nearby distance measurement points, and on the basis of a correlation coefficient between the distance histogram of the predetermined distance measurement point and the distance histogram of the one of the nearby distance measurement points.
   (6)

The signal processing apparatus according to (4) above, in which
the correction unit calculates similarity between the distance histogram of the predetermined distance measurement point and the distance histogram of one of the nearby distance measurement points, by using a distance between a probability density function approximating the distance histogram of the predetermined distance measurement point and a probability density function approximating the distance histogram of the one of the nearby distance measurement points.
   (7)

The signal processing apparatus according to any one of (1) to (6) above, in which
the determination unit determines whether or not three-dimensional coordinates of the predetermined distance measurement point indicated by the distance histogram are a region near an object boundary, and determines that the predetermined distance measurement point is a distance measurement point as a positional deviation check target in a case where the three-dimensional coordinates of the predetermined distance measurement point are the region near the object boundary.
   (8)

The signal processing apparatus according to (7) above, in which
the determination unit detects an edge region of an object included in a captured image obtained by capturing an image of a subject, and determines that three-dimensional coordinates of the predetermined distance measurement point are a region near the object boundary in a case where the three-dimensional coordinates of the predetermined distance measurement point are included in the edge region.
   (9)

The signal processing apparatus according to (8) above, in which
the acquisition unit also acquires the captured image obtained by capturing an image of a range same as that of the distance measurement sensor, and
the determination unit detects an edge region of an object included in the captured image.
   (10)

The signal processing apparatus according to (7) above, in which
the determination unit detects, as an edge region, a region in which movement is detected in a captured image obtained by capturing an image of a subject, and determines that three-dimensional coordinates of the predetermined distance measurement point are a region near the object boundary in a case where the three-dimensional coordinates of the predetermined distance measurement point are included in the edge region.
   (11)

The signal processing apparatus according to (7) above, in which
the determination unit determines whether or not three-dimensional coordinates of the predetermined distance measurement point are a region near the object boundary, by observing a change in the distance histogram over a plurality of frames.
   (12)

The signal processing apparatus according to (11) above, in which
in a case where a number of peak regions in the distance histogram changes in the plurality of frames, the determination unit determines that three-dimensional coordinates of the predetermined distance measurement point are a region near the object boundary.
   (13)

The signal processing apparatus according to (11) or (12) above, in which
in a case where a bin position with a largest count value of the distance histogram has changed in the plurality of frames, the determination unit determines that three-dimensional coordinates of the predetermined distance measurement point are a region near the object boundary.
   (14)

The signal processing apparatus according to any one of (1) to (13) above, further including:
a computation unit configured to compute three-dimensional coordinates of the predetermined distance measurement point from the distance histogram of the predetermined distance measurement point.
   (15)

A signal processing method including,
by a signal processing apparatus:
acquiring a distance histogram that is histogram data of time of flight of irradiation light at a predetermined distance measurement point of a distance measurement sensor;
determining whether or not the predetermined distance measurement point is a distance measurement point as a positional deviation check target; and
executing correction processing of correcting three-dimensional coordinates of the predetermined distance measurement point, the three-dimensional coordinates being computed from the distance histogram, on the basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.

### REFERENCE SIGNS LIST

1 Signal processing system
11 RGB camera
12 dToF sensor
13 Signal processing apparatus
21 Data acquisition unit
22 Distance computation unit
23 Correction processing unit
24 Storage unit
25 Output unit
31 Check target determination unit
32 Coordinate correction unit
71 Check target determination unit
101 CPU
102 ROM
104 Bus
105 Input/output interface
106 Input unit
107 Output unit
108 Storage unit
109 Communication unit
110 Drive
111 Removable recording medium

1. A signal processing apparatus comprising:
an acquisition unit configured to acquire a distance histogram that is histogram data of time of flight of irradiation light at a predetermined distance measurement point of a distance measurement sensor;
a determination unit configured to determine whether or not the predetermined distance measurement point is a distance measurement point as a positional deviation check target; and
a correction unit configured to execute correction processing of correcting three-dimensional coordinates of the predetermined distance measurement point, the three-dimensional coordinates being computed from the distance histogram, on a basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.

2. The signal processing apparatus according to claim 1, wherein
the correction unit executes the correction processing in a case where it is determined that a centroid vector of similarity between the distance histogram of the predetermined distance measurement point and the distance histogram of a nearby distance measurement point near the predetermined distance measurement point coincides with a direction of an object boundary.

3. The signal processing apparatus according to claim 2, wherein
in a case where it is determined that the centroid vector of the similarity coincides with a direction of an object boundary, the correction unit corrects three-dimensional coordinates of the predetermined distance measurement point to a position across the object boundary.

4. The signal processing apparatus according to claim 2, wherein
from the similarity between the distance histogram of the predetermined distance measurement point and the distance histogram of each of a plurality of nearby distance measurement points near the predetermined distance measurement point, the correction unit calculates the centroid vector of the similarity.

5. The signal processing apparatus according to claim 4, wherein
the correction unit calculates similarity between the distance histogram of the predetermined distance measurement point and the distance histogram of one of the nearby distance measurement points, on a basis of a difference between a position vector of the predetermined distance measurement point and a position vector of the one of the nearby distance measurement points, and on a basis of a correlation coefficient between the distance histogram of the predetermined distance measurement point and the distance histogram of the one of the nearby distance measurement points.

6. The signal processing apparatus according to claim 4, wherein
the correction unit calculates similarity between the distance histogram of the predetermined distance measurement point and the distance histogram of one of the nearby distance measurement points, by using a distance between a probability density function approximating the distance histogram of the predetermined distance measurement point and a probability density function approximating the distance histogram of the one of the nearby distance measurement points.

7. The signal processing apparatus according to claim 1, wherein
the determination unit determines whether or not three-dimensional coordinates of the predetermined distance measurement point indicated by the distance histogram are a region near an object boundary, and determines that the predetermined distance measurement point is a distance measurement point as a positional deviation check target in a case where the three-dimensional coordinates of the predetermined distance measurement point are the region near the object boundary.

8. The signal processing apparatus according to claim 7, wherein
the determination unit detects an edge region of an object included in a captured image obtained by capturing an image of a subject, and determines that three-dimensional coordinates of the predetermined distance measurement point are a region near the object boundary in a case where the three-dimensional coordinates of the predetermined distance measurement point are included in the edge region.

9. The signal processing apparatus according to claim 8, wherein
the acquisition unit also acquires the captured image obtained by capturing an image of a range same as that of the distance measurement sensor, and
the determination unit detects an edge region of an object included in the captured image.

10. The signal processing apparatus according to claim 7, wherein
the determination unit detects, as an edge region, a region in which movement is detected in a captured image obtained by capturing an image of a subject, and determines that three-dimensional coordinates of the predetermined distance measurement point are a region near the object boundary in a case where the three-dimensional coordinates of the predetermined distance measurement point are included in the edge region.

11. The signal processing apparatus according to claim 7, wherein
the determination unit determines whether or not three-dimensional coordinates of the predetermined distance measurement point are a region near the object boundary, by observing a change in the distance histogram over a plurality of frames.

12. The signal processing apparatus according to claim 11, wherein
in a case where a number of peak regions in the distance histogram changes in the plurality of frames, the determination unit determines that three-dimensional coordinates of the predetermined distance measurement point are a region near the object boundary.

13. The signal processing apparatus according to claim 11, wherein
in a case where a bin position with a largest count value of the distance histogram has changed in the plurality of frames, the determination unit determines that three-dimensional coordinates of the predetermined distance measurement point are a region near the object boundary.

14. The signal processing apparatus according to claim 1, further comprising:
a computation unit configured to compute three-dimensional coordinates of the predetermined distance measurement point from the distance histogram of the predetermined distance measurement point.

15. A signal processing method comprising
by a signal processing apparatus:
acquiring a distance histogram that is histogram data of time of flight of irradiation light at a predetermined distance measurement point of a distance measurement sensor;
determining whether or not the predetermined distance measurement point is a distance measurement point as a positional deviation check target; and
executing correction processing of correcting three-dimensional coordinates of the predetermined distance measurement point, the three-dimensional coordinates being computed from the distance histogram, on a basis of a determination result of similarity between the distance histogram of the predetermined distance measurement point and the distance histogram of a nearby distance measurement point near the predetermined distance measurement point, in a case where the predetermined distance measurement point is a distance measurement point as a positional deviation check target.
